(19) United States
(12) Patent Application Publication
(10) Pub. No.: US 2012/0098337 A1
(43) Pub. Date: Apr. 26, 2012

(54) ELECTRIC POWER PATH SWITCHING METHOD AND ELECTRIC POWER PATH SWITCHING CIRCUIT

(76) Inventor: Teruo Sasaki, Shizuoka (JP)

(21) Appl. No.: 13/223,819

(22) Filed: Sep. 1, 2011

(30) Foreign Application Priority Data
Oct. 22, 2010 (JP) 237429/2010

(51) Int. Cl. H02J 7/34

(52) U.S. Cl. 307/23

(57) ABSTRACT

An electric power path switching method for switching a first electric power path from a built-in rechargeable battery in a communication device and a second electric power path from a charger for charging the rechargeable battery which can be connected to the communication device by plugging in and out, includes dividing a load of the communication device into two systems of a first load and a second load; supplying electric power to the first load from the first electric power path; and supplying electric power to the second load from the second electric power path when charging the rechargeable battery by the charger and from the first electric power path when the rechargeable battery is not charged.

### INCORPORATION BY REFERENCE

This application is based upon and claims the benefit of priority from Japanese Patent Application No. JP 2010-237429, filed on Oct. 22, 2010, the disclosure of which is incorporated herein in its entirety by reference.

### BACKGROUND OF THE INVENTION

1. Technical Field

The present invention relates to an electric power path switching method and an electric power path switching circuit, for example, to an electric power path switching method and an electric power path switching circuit which switch the first electric power path from a built-in rechargeable battery in a communication device and the second electric power path from a charger (AC (Alternating Current) adapter) that can plug in and out to a communication device.

2. Background Art

In a system such as a portable device (mobile data terminal, for example) with a relatively small electric power, a linear charge which has a simple configuration may be used for a charge of a built-in rechargeable battery of a mobile data terminal. However, nowadays there is a great need for strengthening the function and the power consumption of mobile data terminal is becoming large.

In a configuration of the conventional linear charge, when the power consumption of the device block (load) of a mobile data terminal becomes large, a carrying out from a rechargeable battery occurs while charging from a charger (AC adapter, for example) to a rechargeable battery.

Here, “carrying out from a rechargeable battery” represents a state of necessity to supply electric power to a mobile data terminal (load) from a rechargeable battery when a device current (consumption current) becomes larger than a charging current (device current>charging current) even while charging the rechargeable battery. When in such case, even if a rechargeable battery is being charged, battery capacity of the rechargeable battery decreases, therefore there is a need to avoid such state.

Various prior arts related to the present invention are known.

For example, in Japanese Patent Application Laid-Open No. 2006-340586 (paragraph [0044]) (patent document 1), a mobile data terminal and the control method which increase a current from a charger and avoids a carrying out of a current from a battery when consumption current is larger than a charging current, is disclosed.

Further, as a power supply method to a power device, Japanese Unexamined Patent Application Publication No. 2009-502110 (FIG. 1 and paragraph [0017]) (patent document 2) proposes a switching using a diode and a switching using FET (Field-Effect Transistor). For example, patent document 2 discloses an input selection circuit equipped with a series diode which provides selection of a battery connected by logical OR composition or a wall adapter. When a voltage generated by one input power source is higher than the voltage generated by another power source only for the voltage drop of one diode, the electric power is taken from a power source of the higher one.

Further, Japanese Patent Application Laid-Open No. 2006-296126 (patent document 3) proposes a switching in an electric power path supplied to a charging circuit. Patent document 3 discloses a charging system which can select a USB (Universal Serial Bus) bus power source and an AC adapter power source as a power source for charging.

Japanese Patent Application Laid-Open No. 2005-312218 (FIG. 3 and paragraph [0022] and [0044]) (patent document 4) discloses a power source switching circuit which can reliably perform a switching to a battery when a supply of voltage from an external power source is suspended. The power source switching circuit disclosed by patent document 4 includes an external power source input, a battery power source input, an external power source system, a battery power source system, a selection circuit, an output terminal, and an electrolytic capacitor. The external power source input is a terminal which a first power source voltage is supplied from an external power source. The battery power source input is a terminal which a second power source voltage is supplied from a battery. The external power source system is a circuit for outputting the first power source voltage supplied from the external power source, from an output terminal. The battery power source system is a circuit for outputting the second power source voltage supplied from a battery, from an output terminal. The selection circuit is a circuit for selecting the output voltage outputted from the output terminal from the first power source voltage supplied from the external power source and the second power source voltage supplied from the battery. The electrolytic capacitor is installed between the output terminal and an earth terminal, and it is used in order to stabilize the output voltage generated in the output terminal. In addition, patent document 4 further discloses a Schottky Barrier Diode which prevents the second power source voltage from the battery power source flowing backward in the external power source input when switching the output voltage.

### SUMMARY

An exemplary object of the present invention is to provide an electric power path switching method and an electric power path switching circuit that a radiation measure is not necessary and a carrying out from a rechargeable battery will not occur.

An electric power path switching method for switching a first electric power path from a built-in rechargeable battery in a communication device and a second electric power path from a charger for charging the rechargeable battery which can be connected to the communication device by plugging in and out, includes dividing a load of the communication device into two systems of a first load and a second load; supplying electric power to the first load from the first electric power path; and supplying electric power to the second load from the second electric power path when charging the rechargeable battery by the charger and from the first electric power path when the rechargeable battery is not charged.

### BRIEF DESCRIPTION OF THE DRAWINGS

Exemplary features and advantages of the present invention will become apparent from the following detailed description when taken with the accompanying drawings in which:

FIG. 1 is a block diagram showing a composition of a mobile data terminal (communication device) having an electric power path switching circuit according to a first embodiment of the present invention;

FIG. 2 is a wave form chart of a voltage (a switched voltage) that is applied to a second device block (a second load), for describing an operation of the electric power path switching circuit shown in FIG. 1;

FIG. 3 is a block diagram showing a composition of a mobile data terminal (communication device) having an electric power path switching circuit according to a second embodiment of the present invention;

FIG. 4 is a wave form chart of a voltage (a switched voltage) that is applied to a second device block (a second load), for describing an operation of the electric power path switching circuit shown in FIG. 3;

FIG. 5 is a block diagram showing a composition of a mobile data terminal (communication device) having an electric power path switching circuit according to a third embodiment of the present invention;

FIG. 6 is a figure showing a control method of a comparator which is used for the electric power path switching circuit shown in FIG. 5;

FIG. 7 is a wave form chart of a voltage (a switched voltage) that is applied to a second device block (a second load), for describing an operation of the electric power path switching circuit shown in FIG. 5;

FIG. 8 is a block diagram showing a composition of a mobile data terminal (communication device) having an electric power path switching circuit according to a fourth embodiment of the present invention;

FIG. 9 is a figure showing a control method of a comparator which is used for the electric power path switching circuit shown in FIG. 8; and

FIG. 10 is a block diagram showing the composition of the mobile data terminal (communication device) having a related electric power feeding path.

### EXEMPLARY EMBODIMENT

Next, embodiments for carrying out the invention will be described in detail with reference to the drawings.

First, features of the invention will be described.

A first embodiment of the present invention is characterized in that a carrying out from a rechargeable battery does not occur by dividing a device block (load) into two systems (a first device block and a second device block), since a carrying out from a rechargeable battery occurs in a related linear charge configuration when a device current (consumption current) exceeds a charging current.

A second embodiment of the present invention is characterized in that in order to deny a reverse current of Schottky Barrier Diode (SBD) when AC adapter is inserted, (a resistor+Metal-Oxide-Semiconductor Field-Effect Transistor (N-channel MOSFET)) is provided.

A third embodiment of the present invention is characterized by composing how to separate two systems of device block as a current of the whole device when being battery driven, may become the smallest.

A fourth embodiment of the present invention is characterized by composing how to separate two systems of device block as charging current to a battery may become the greatest.

A fifth embodiment of the present invention is characterized by allotting a device with a high lower-limit of a recommended operating range to a first device block with priority.

A sixth embodiment of the present invention is characterized by allotting a device with a low upper-limit of a recommended operating range to a first device block with priority.

A seventh embodiment of the present invention is characterized by allotting a device with a high operation frequency to a first device block with priority.

An eighth embodiment of the present invention is characterized in that it is applicable to a high-power in linear charge by a simple configuration using SBD.

A ninth embodiment of the present invention is characterized in that it is applicable to a high-power in linear charge by a simple configuration using (SBD+FET).

A tenth embodiment of the present invention is characterized in that it is applicable to a high-power in a linear charge by a simple configuration by using (P-channel MOSFET+comparator).

An eleventh embodiment of the present invention is characterized in that wraparound from a charge path is not generated in SBD by using (P-channel MOSFET+comparator).

A twelfth embodiment of the present invention is characterized in that wraparound from a charge path is not generated by using (P-channel MOSFET+comparator).

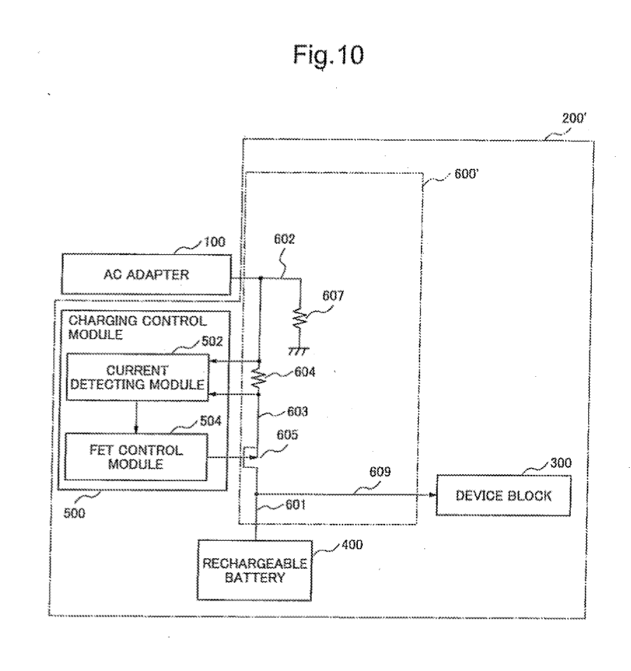

Next, in order to understand the present invention easily, a related linear charge configuration will be described by referring to FIG. 10. FIG. 10 is a block diagram showing the composition of a mobile data terminal (communication device) 200′ having a related electric power feeding path 600′.

As shown in FIG. 10, an AC adapter (charger) 100 which supplies a DC voltage from external is connected to the mobile data terminal 200′ as it can be plugged in and out. A mobile data terminal 200′ is equipped with one device block 300 as a load and contains a rechargeable battery 400. The device block (load) 300 includes a plurality of blocks constituted in the communication device (mobile data terminal) 200′. For example, the rechargeable battery 400 is composed of a lithium ion battery, however it is not limited thereto.

The mobile data terminal 200′ is equipped with a charge control module 500 which controls a charge from the AC adapter (charger) 100 to the rechargeable battery 400. The charge control module 500 is a charge control module which performs a linear charge. The electric power feeding path 600′ is formed (configured) among the AC adapter (charger) 100, the device block (load) 300, the rechargeable battery 400, and the charge control module 500.

The electric power feeding path 600′ has a first electric power path 601 from the rechargeable battery 400, a second electric power path 602 from the AC adapter (charger) 100, and a charge path 603 which supplies a charging current from the AC adapter (charger) 100 to the rechargeable battery 400.

A resistor 604 and P-channel MOSFET 605 are connected in series in the charge path 603. More specifically, one end of the resistor 604 is connected to the second electric power path 602, and the other end of the resistor 604 is connected to a source of P-channel MOSFET 605. A drain of P-channel MOSFET 605 is connected to the first electric power path 601.

The electric power feeding path 600′ further has a resistor 607 connected to the second electric power path 602. That is, the resistor 607 is inserted between the second electric power path 602 and an earth terminal. In order not to have an electric charge left when the AC adapter (charger) 100 is removed from the mobile data terminal 200′, the resistor 607 is generally placed.

The charge control module 500 of a linear charge includes a current detection module 502 and a FET control module 504. The current detection module 502 calculates the current value of the charging current from the voltage between the terminals of the resistor 604 inserted in the above-mentioned charge path 603. Based on the calculated current value, the FET control module 504 controls a gate voltage of P-channel MOSFET 605 as the charging current will be the desired current value and controls the charging current. The charging current is supplied to the rechargeable battery 400 via the charge path 603, and the rechargeable battery 400 will be charged.

The electric power feeding path 600′ further has an electricity feeding path 609 for supplying electric power to the device block (load) 300. One end of the electricity feeding path 609 is connected to a connection point of the first electricity feeding path 601 and the charge path 603, and the other end of the electricity feeding path 609 is connected to the device block (load) 300. That is, the electric power of the rechargeable battery 400 is supplied to the device block (load) 300 via the first electric power path 601 and the electricity feeding path 609. Further, the electric power of the AC adapter (charger) 100 is supplied to the device block (load) 300 via the second electric power path 602, the charge path 603, and the electricity feeding path 609.

In the linear charge configuration (the electric power feeding path 600′) having a configuration as described above, when the power consumption (the device electric power) of the device block 300 becomes large, a carrying out from the rechargeable battery 400 occurs during a charge as previously mentioned. For this reason, as described (disclosed) in the above-mentioned patent document 1, the charging current needs to be made large.

However, when the charging current is made large the loss of P-channel MOSFET 605 becomes great, therefore it will not thermally last. As a result, a radiation measure or the like at the external will be needed, and there was a problem that the merit of using the simple linear charge will disappear.

As previously mentioned, when it is “charging current<device current (consumption current)”, the carrying out from the above-mentioned rechargeable battery 400 represents a state of necessity to supply electric power to the device block (load) 300 from the rechargeable battery 400 even during a charge. When in such case, even if the rechargeable battery 400 is being charged, battery capacity of the rechargeable battery 400 decreases, therefore there is a need to avoid having such state to occur.

### First Embodiment

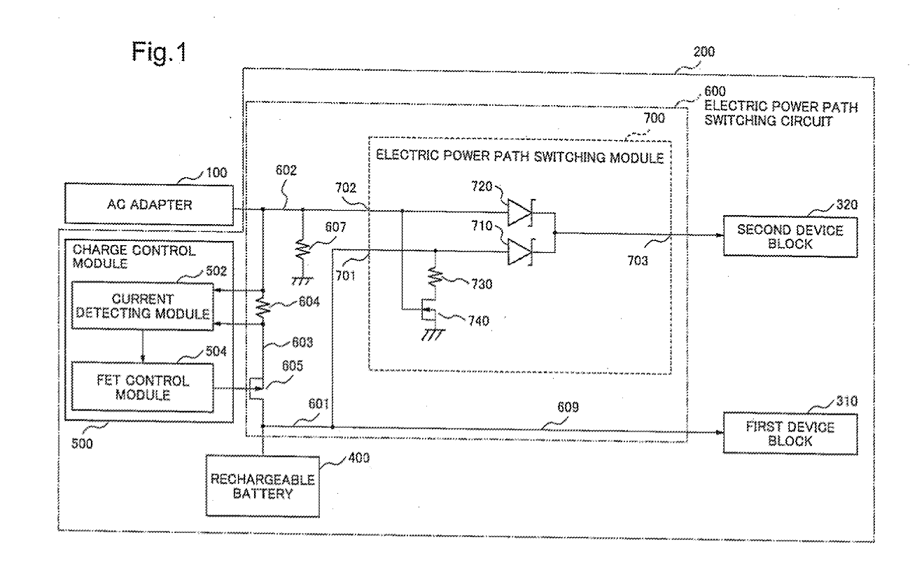

A mobile data terminal 200 including an electric power path switching circuit 600 according to a first embodiment of the present invention will be described with reference to FIG. 1. Further, in an example of illustration, although the mobile data terminal 200 is given as an example and being described, it is also applied to other communication devices.

The mobile data terminal 200 as illustrated divides a device block (load) to two systems in a first device block (the first load) 310 and a second device block (the second load) 320 together with having the same configuration as the mobile data terminal 200′ shown in FIG. 10, except for a point that is equipped with the electric power path switching circuit 600 instead of the electric power feeding path 600′. Accordingly, in FIG. 1, the same reference numeral is given to the same components as shown in FIG. 10. Further, for the simplification of description, only the points different from related mobile data terminal 200′ will be described below.

As previously mentioned, when a device current (consumption current) exceeds a charging current (device current>charging current), a carrying out from a rechargeable battery 400 occurs in related mobile data terminal 200′. Accordingly, in this first embodiment, by dividing the device block (load) to two systems in the first device block (the first load) 310 and the second device block (the second load) 320, it is composed as not having a carrying out from the rechargeable battery 400 to occur. Further, a description of a method to cut and divide (to allot) the first device block (the first load) 310 and the second device block (the second load) 320 will be hereinafter described.

The electric power path switching circuit 600 operates by having the same configuration as the electric power feeding path 600′ shown in FIG. 10 except for a point that it further has an electric power path switching module 700.

An electricity feeding path 609 supplies electric power to the first device block (the first load) 310 from a first electric power path 601. On the other hand, the electric power path switching module 700, as hereinafter described, switches the first electric power path 601 and a second electric power path 602 and supplies the electric power from the switched electric power path to the second device block (the second load) 320.

When an AC adapter (charger) 100 is not connected to the mobile data terminal (communication device) 200, the electric power path switching module 700 supplies as the electric power that switched the electric power from the first electric power path 601 to the second device block (the second load) 320. On the other hand, when the AC adapter (charger) 100 is connected to the mobile data terminal (communication device) 200, the electric power path switching module 700 supplies as the electric power that switched the electric power from the second electric power path 602 to the second device block (the second load) 320.

In other words, the electric power is supplied from the first electric power path 601 to the first device block (the first load) 310. In the second device block (the second load) 320, during a charge of a rechargeable battery 400 by an AC adapter (charger) 100 the electric power is supplied from the second electric power path 602, and during non-charge of a rechargeable battery 400 the electric power is supplied from the first electric power path 601.

The electric power path switching module 700 as shown has a first input edge 701 connected to the first electric power path 601, a second input edge 702 connected to the second electric power path 602, and an output edge 703 which outputs the above-mentioned switched electric power.

The electric power path switching module 700 has a first conducting device and a second conducting device. The first conducting device is inserted between the first input edge 701 and the output edge 703. The first conducting device is conducted to the output edge 703 as the electric power that switched the electric power from the first electric power path 601. The second conducting device is inserted between the second input edge 702 and the output edge 703. The second conducting device is conducted to the output edge 703 as the electric power that switched the electric power from the second electric power path 602.

In an example of illustration, the first conducting device is composed of a first Schottky Barrier Diode (henceforth, it is abbreviated to “SBD”) 710. In addition, the second conducting device is composed of a second SBD 720.

That is, a switch of electric power path in the electric power path switching module 700 is performed by first SBD 710 and second SBD 720. For electric power path to the second device block (the second load) 320, there are the first electric power path 601 supplied from the charge path 603 or the rechargeable battery 400, and the second electric power path 602 supplied from the AC adapter (charger) 100. The electric power path switching module 700 switches the first electric power path 601 and the second electric power path 602 and supplies the electric power. The electric power is supplied to the second device block (the second load) 320 via the second SDB 720 when the AC adapter (charger) 100 is inserted. The electric power is supplied to the second device block (the second load) 320 via the first SDB 710 when the AC adapter (charger) 100 is not inserted.

Here, using the SDB as a conducting device is for the following reasons. That is, in order to minimize a loss of the electric power path switching module 700, a low voltage drop (henceforth, it is abbreviated to “Vf”) of a forward direction is necessary and a switching speed needs to be fast, therefore it is desirable to use the SBD.

However on the other hand, the SBD has characteristics of having a large opposite direction leakage current. Therefore, when the voltage applied on the second device block (the second load) 320 exceeds absolute maximum rating voltage+Vf (SBD 710) of the rechargeable battery 400 when inserting the AC adapter (charger) 100, it may overcharge the rechargeable battery 400 by a reverse current and give damage to the rechargeable battery 400.

Accordingly, in the electric power path switching circuit 600 according to this first embodiment, the electric power path switching module 700 is further equipped with a backflow prevention circuit in order not to have flow the above-mentioned reverse current into the rechargeable battery 400 side only when inserting the AC adapter (charger) 100 (that is, when the AC adapter (charger) 100 is connected to the mobile data terminal (communication device) 200).

In an example of illustration, the backflow prevention circuit is composed of a resistor 730 and an N-channel MOSFET 740. One end of the resistor 730 is connected to the first input edge 701, and the other end of the resistor 730 is connected to a drain of the N-channel MOSFET 740. A gate of the N-channel MOSFET 740 is connected to the second input edge 702, and a source of the N-channel MOSFET 740 is grounded.

Further, in an example of illustration, although a backflow prevention circuit is composed of the resistor 730 and the N-channel MOSFET 740, an npn bipolar transistor may be used instead of the N-channel MOSFET 730. In this case, in the npn bipolar transistor, the collector is connected to other end of the resistor 730, the base is connected to the second input edge 702, and the emitter is grounded.

A gate voltage of the N-channel MOSFET 740 will be a logical high level when inserting the AC adapter (charger) 100, and the N-channel MOSFET 740 will be in an ON state. For this reason, a reverse current of the first SBD 710 flows to an earth terminal via the resistor 730 and the N-channel MOSFET 740 and an overcharge to the rechargeable battery 400 will not occur. For the resistance value of the resistor 730, a value of the degree of denying a reverse current of the first SBD 710 is suitable. Further, because the gate voltage of N-channel MOSFET 740 is not applied when the AC adapter (charger) 100 is not inserted, N-channel MOSFET 740 will be in an OFF state and has a configuration which does, not have an influence on a circuit operation.

Next, how to divide (layout) the device block (load) will be described.

For example, for dividing the first SBD 710 and the second SBD 720 as to minimize a loss, there is a method to allot the first device block (the first load) 310 as it will be just barely less than the charging current, and allot a remaining block to the second device block (the second load) 320. By composing as the above-mentioned, it is possible to have the power consumption of the second device block (the second load) 320 the smallest without generating a carrying out from the rechargeable battery 400. Therefore, a loss in the first SBD 710 can be held to a minimum, and there is an advantage of reducing a current by the whole device when the rechargeable battery 400 is driving.

Further, a device which cannot permit Vf of the first SBD 710 because of a high lower-limit of a recommended operating voltage is allotted with priority to the first device block (the first load) 310. Alternatively in an opposite manner, a device which cannot permit {(the voltage of the AC adapter 100)−(Vf of the first SBD 720)} because of a low upper-limit of a recommended operating voltage is allotted with priority to the first device block (the first load) 310.

In addition, depending on a block, there is one with a low and one with a high operation frequency. It is desirable to allot with priority a block with the high operation frequency to the first device block (the first load) 310 which has a small loss. However, because a current charged to the rechargeable battery 400 becomes small when the power consumption of the first device block (the first load) 310 becomes large in the layout hereof, there is a disadvantage of taking time before the rechargeable battery 400 will be in full charge.

As another example of how to divide the device block (load), there is a method not to reduce charging current to the rechargeable battery 400 as much as possible. In this method, a minimal block is allotted to the first device block (the first load) 310, and the rest is allotted to the second device block (the second load) 320. However, in this case, a loss of the first SBD 710 becomes large. Therefore, in this method, it will be a disadvantage that a current by the whole device increases and that a heat production in the first SBD 710 becomes large.

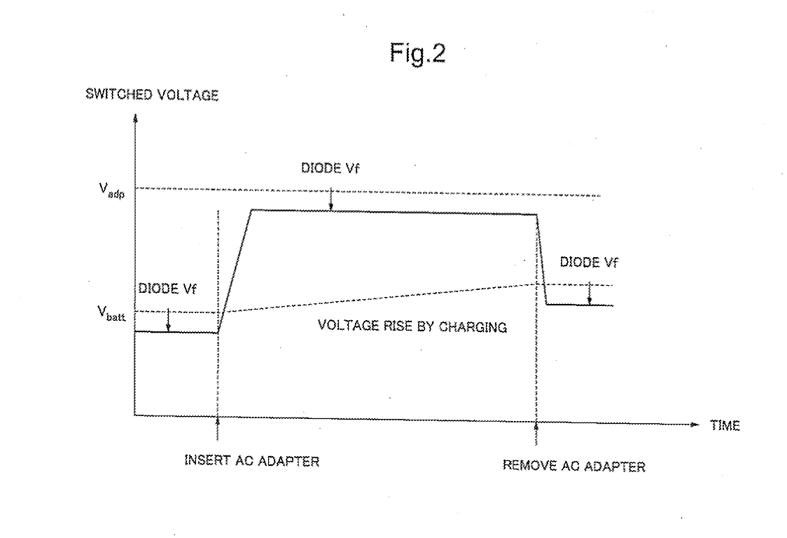

Next, operation of the electric power path switching circuit 600 shown in FIG. 1 will be described with reference to FIG. 2. In FIG. 2, the horizontal axis indicates time and the vertical axis indicates the switched voltage (the voltage applied on the second device block 320). Further, in FIG. 2, the voltage of the first input edge 701 is marked as a battery voltage Vbatt, and the voltage of the second input edge 702 is marked as AC adapter voltage Vadp.

The voltage (the switched voltage) applied on the second device block (the second load) 320 will be described using FIG. 2.

The mobile data terminal (communication device) 200 operates only by the rechargeable battery 400 when the AC adapter (charger) 100 is not inserted. Therefore, the voltage (the switched voltage) applied on the second device block (the second load) 320 will be {Vbatt−Vf (the first SBD 710)}. When the AC adapter (charger) 100 is inserted into the mobile data terminal (communication device) 200, an electric power path supplied to the second device block (the second load) 320 will be via the second SBD 720 side from the second electric power path 602. For this reason, the switched voltage will be {Vadp−Vf (the second SBD 720)}. Moreover, when the AC adapter (charger) 100 is removed from the mobile data terminal (communication device) 200, it will be the same path as when not having the above-mentioned AC adapter (charger) 100 inserted. Because the rechargeable battery 400 is charged when the AC adapter (charger) 100 is inserted, the battery voltage hereof will rise.

In the first embodiment of the present invention described above, there are advantageous effects as indicated below.

The first effect is that because a device block (load) was divided into two systems in the first device block (the first load) 310 and the second device block (the second load) 320, it is possible not to have a carrying out from the rechargeable battery 400 to occur.

The second effect is that because backflow prevention circuits (730,740) which prevents a reverse current flowing is installed in the rechargeable battery 400 via the first conducting device 710 when the AC adapter (charger) 100 is inserted, it is possible to prevent an overcharge to the rechargeable battery 400.

### Second Embodiment

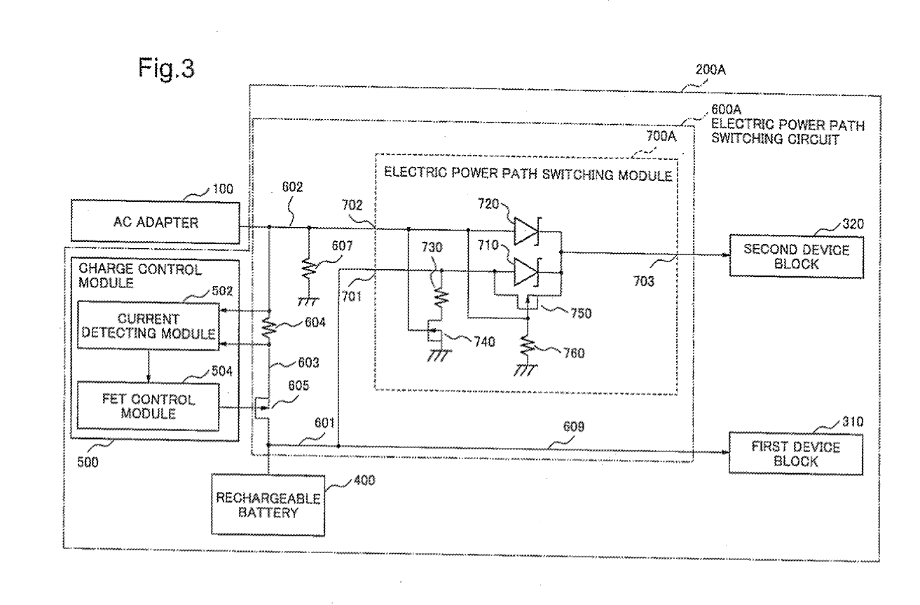

A mobile data terminal 200A including an electric power path switching circuit 600A according to the second embodiment of the present invention will be described with reference to FIG. 3. Further, in an example of illustration, although the mobile data terminal 200A is given as an example and being described, it is also applied to other communication devices.

The electric power path switching circuit 600A has the same configuration as the electric power path switching circuit 600 shown in FIG. 1 and operates except for a point that the composition of the electric power path switching module is changed as described below. Accordingly, reference numerals of 700A are given to the electric power path switching module. The same reference numeral is given to the same components as shown in FIG. 1, and for the simplification of description, only the points different from the mobile data terminal 200 is hereinafter described.

When an AC adapter (charger) 100 is not connected to the mobile data terminal (communication device) 200A, the electric power path switching module 700A has the same configuration as the electric power path switching module 700 shown in FIG. 1 and operates, except for a point that it further has a first loss reduction circuit that reduces a loss which occurs in a first SBD 710 that operates as a first conducting device.

In an example of illustration, the first loss reduction circuit is composed of a P-channel MOSFET 750 and a resistor 760. In the P-channel MOSFET 750, the drain is connected to a first input edge 701, and the source is connected to an output edge 703, and a gate is connected to a second input edge 702. The resistor 760 is connected between the gate of the P-channel MOSFET 750 and the earth terminal.

In the electric power path switching circuit 600 according to the first embodiment shown in FIG. 1, the voltage (the switched voltage) applied on the second device block (the second load) 320 will be {Vbatt−Vf (the first SBD 710)} when inserting the AC adapter (charger) 100, and performs a voltage drop only for Vf of the first SBD 701. Therefore, for the electric power path switching circuit 600 according to the first embodiment has room for improvement in losses.

In contrast, in the electric power path switching circuit 600A according to the second embodiment shown in FIG. 3, it is different in a point that the loss is not to occur.

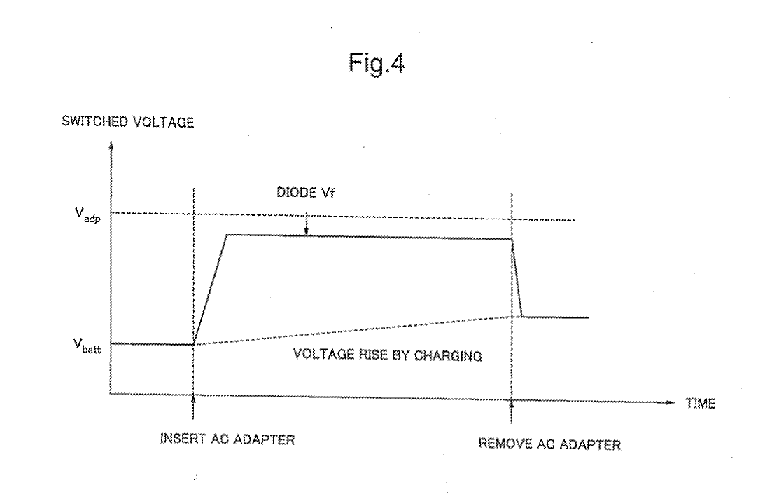

In detail, because a gate voltage of the P-channel MOSFET 750 will be the ground level in the resistor 760, the P-channel MOSFET 750 will be in ON state when the AC adapter (charger) 100 is not inserted. Therefore, as shown in FIG. 4, Vf will not occur in the first SBD 710.

FIG. 4 is a figure showing the voltage (the switched voltage) applied on a second device block (the second load) 320 in the mobile data terminal (communication device) 200A shown in FIG. 3. In FIG. 4, the horizontal axis indicates time and the vertical axis indicates the switched voltage (the voltage applied on the second device block 320). Further, in FIG. 4, the voltage of the first input edge 701 is marked as battery voltage Vbatt, and the voltage of the second input edge 702 is marked as AC adapter voltage Vadp.

A loss in the P-channel MOSFET 750 is decided on the ON resistance by a current. Accordingly, by selecting the P-channel MOSFET 750 with a small resistance, it is possible to design significantly smaller than Vf in the first SBD 710.

On the other hand, because a gate voltage of the P-channel MOSFET 750 will be AC adapter voltage Vadp, the P-channel MOSFET 750 will be in OFF state when inserting the AD adapter (charger) 100. As a result, the electric power path in the electric power path switching module 700A will be to switch over to a second SBD 720 side from a second electric power path 602.

Next, a necessity of the first SBD 710 will be described. When the P-channel MOSFET 750 is turned ON or turned OFF, there is a momentarily timing of not having any supply of electric power neither from the AC adapter 100 nor the rechargeable battery 400. For this reason, the first SBD 710 is needed.

In the second embodiment of the present invention described above, there are advantageous effects as indicated below.

The first effect is that because a device block (load) is divided into two systems in a first device block (the first load) 310 and the second device block (the second load) 320, it is possible not to have a carrying out from the rechargeable battery 400.

The second effect is that because backflow prevention circuits (730,740) which prevents a reverse current flowing is installed in the rechargeable battery 400 via the first conducting device 710 when the AC adapter (charger) 100 is inserted, it is possible to prevent an overcharge to the rechargeable battery 400.

The third effect is that because the first loss reduction circuit (750 or 760) that reduces a loss which occurs in the first conducting device 710 is installed when the AC adapter (charger) 100 is inserted, it is possible to improve a loss.

### Third Embodiment

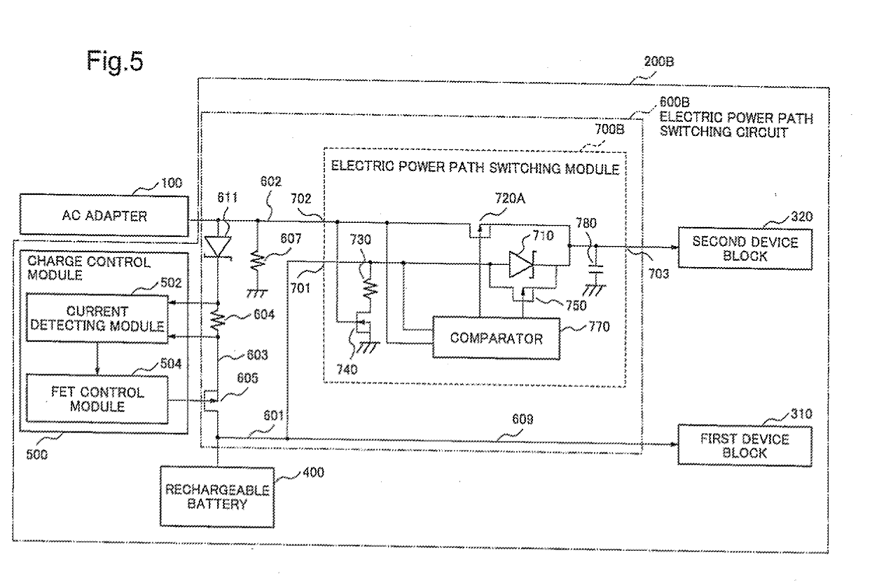

A mobile data terminal 200B including an electric power path switching circuit 600B according to the third embodiment of the present invention will be described with reference to FIG. 5. Further, in an example of illustration, although the mobile data terminal 200B is given as an example and being described, it is also applied to other communication devices.

The electric power path switching circuit 600B of illustration has the same configuration as the electric power path switching circuit 600 shown in FIG. 1 and operates except for points that the configuration of an electric power path switching module is changed as described below and that a SBD 611 is inserted in a charge path 603. Accordingly, reference numerals of 700B are given to the electric power path switching module. The same reference numeral is given to the same components as shown in FIG. 1, and for the simplification of description, only the points different from the mobile data terminal 200 is hereinafter described.

In the electric power path switching module 700B of an example of illustration, a first conducting device is composed of a SBD 710 and a first P-channel MOSFET 750. An anode of the SBD 710 is connected to a first input edge 701, and a cathode of the SBD 710 is connected to an output edge 703. In the first P-channel MOSFET 750, the drain is connected to the first input edge 701, and the source is connected to an output edge 703.

Further, in the electric power path switching module 700B of an example of illustration, a second conducting device is composed of a second P-channel MOSFET 720A. In the second P-channel MOSFET 720A, the drain is connected to a second input edge 702, and the source is connected to an output edge 703.

Further, the electric power path switching module 700B further has a second loss reduction circuit that reduces a loss which occurs by the second P-channel MOSFET 720A that operates as the second conducting device when an AC adapter (charger) 100 is connected to the mobile data terminal (communication device) 200B.

In an example of illustration, the second loss reduction circuit is composed of a comparator 770 and a capacitor 780. The comparator 770 compares the voltage of the first input edge 701 and the voltage of the second input edge 702 and by the comparison result controls the gate voltage of the first P-channel MOSFET 750 and the second P-channel MOSFET 720A as described below. The capacitor 780 is inserted between the output edge 703 and the earth terminal.

In the electric power path switching circuit 600A according to the second embodiment shown in FIG. 3, the voltage (the switched voltage) applied on the first device block (the second load) 320 will be {Vadp−Vf (second SBD 720)}, and performs a voltage drop only for Vf of the second SDB 720 when inserting the AC adapter (charger) 100. For this reason, the electric power path switching circuit 600A according to the second embodiment has room for improvement in losses.

In contrast, in the electric power path switching circuit 600B according to the third embodiment, it is different in a point that the loss is not to occur.

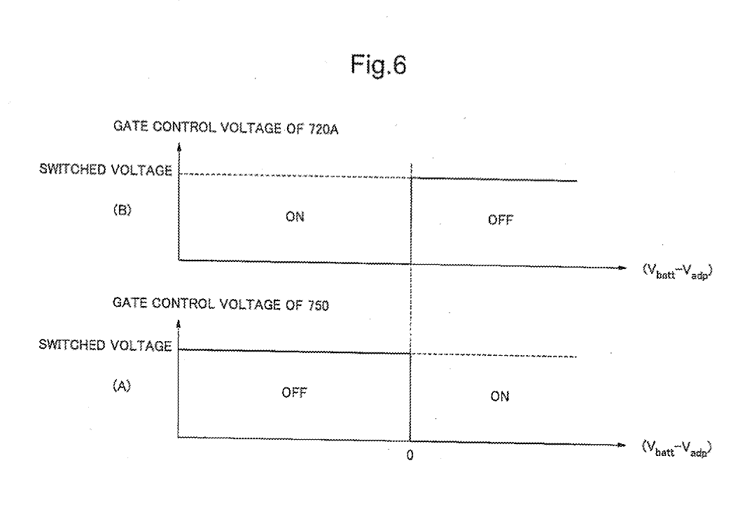

FIG. 6 is a figure showing a control method of the comparator 770. In FIG. 6, (A) indicates gate control voltage of the first P-channel MOSFET 750, and (B) indicates gate control voltage of the second P-channel MOSFET 720A. In (A) and (B) of FIG. 6, the horizontal axis indicates (Vbatt−Vadp), and the vertical axis indicates gate control voltage (the switched voltage).

The comparator 770 compares a battery voltage (the voltage of the first input edge 701) Vbatt and an AC adapter voltage (the voltage of the second input edge 702) Vadp and controls a gate control voltage of the first P-channel MOSFET 750 and the second P-channel MOSFET 720A by the magnitude.

More specifically, it is supposed that the AC adapter (charger) 100 is not inserted. At that time, the battery voltage Vbatt becomes higher than the AC adapter voltage Vadp. In such case, the comparator 770 switches the first P-channel MOSFET 750 into an ON state having the gate control voltage of the first P-channel MOSFET 750 into a logical low level. At the same time, the comparator 770 switches the second P-channel MOSFET 720A into an OFF state having the gate control voltage of the second P-channel MOSFET 720A into a logical high level.

On the other hand, it is supposed that the AC adapter (charger) 100 is inserted. At that time, the battery voltage Vbatt becomes lower than the AC adapter voltage Vadp. In such case, the comparator 770 switches the first P-channel MOSFET 750 into an OFF state having the gate control voltage of the first P-channel MOSFET 750 into a logical high level conversely. At the same time, the comparator 770 switches the second P-channel MOSFET 720A into an ON state having the gate control voltage of the second P-channel MOSFET 720A into a logical low level.

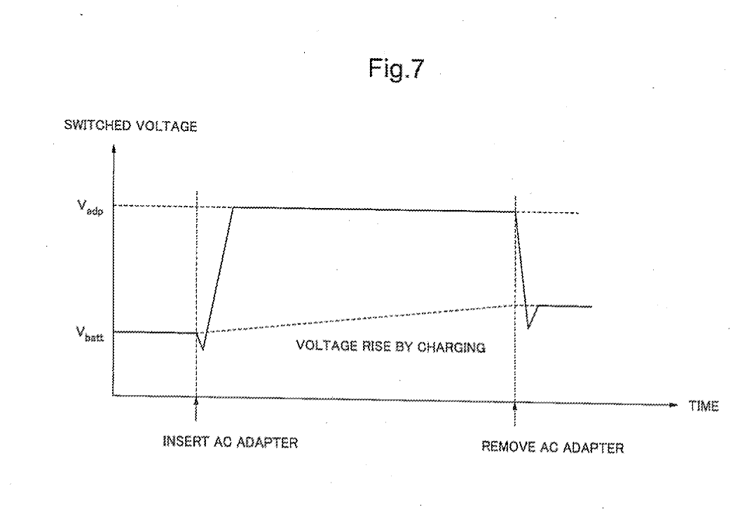

By composing as above-mentioned, the voltage (the switched voltage) supplied to the second device block (the second load) 320 will be as shown in FIG. 7.

FIG. 7 is a figure showing the voltage (the switched voltage) applied on the second device block (the second load) 320 in the mobile data terminal (communication device) 200B shown in FIG. 5. In FIG. 7, the horizontal axis indicates time and the vertical axis indicates the switched voltage (the voltage applied on the second device block 320). Further, in FIG. 7, the voltage of the first input edge 701 is marked as a battery voltage Vbatt, and the voltage of the second input edge 702 is marked as an AC adapter voltage Vadp.

Because the voltage (the switched voltage) applied on the second device block (the second load) 320 is decided on the ON resistance of the second P-channel MOSFET 720A by a current when the AC adapter (charger) 100 is inserted, by selecting the second P-channel MOSFET 720A with a small resistance compared with a voltage drop of Vf of the second SBD 720 in the second embodiment, it is possible to design a voltage drop significantly smaller than Vf of the second SBD 720.

Next, a necessity of the capacitor 780 inserted between the output edge 703 and the earth terminal will be described. When the first P-channel MOSFET 750 and the second P-channel MOSFET 720A are switched in the comparator 770, a section which becomes off together occurs. Therefore, in order to provide a power supply to the second device block (the second load) 320 in such case, the capacitor 780 is being placed.

Moreover, a necessity of the SBD 611 in the charge path 603 inserted between the output terminal of the AC adapter (charger) 100 and the P-channel MOSFET 605 will be described. It is supposed that the AC adapter (charger) 100 is removed from the mobile data terminal (communication device) 200B during a charge of the rechargeable battery 400. In this case, because it is in an ON state, when the SBD 611 does not exist, the battery voltage Vbatt can be seen on the side of the AC adapter (charger) 100 via the P-channel MOSFET 605 and the resistor 604. As a result, the AC adapter voltage Vadp which is being inputted to the comparator 770 stays and creates an erroneous operation of the comparator 770. As a measure, in order to prevent wraparound of the voltage, the SBD 611 is needed.

In the third embodiment of the present invention described above, there are advantageous effects as described below.

The first effect is that because a device block (load) was divided into two systems in the first device block (the first load) 310 and the second device block (the second load) 320, it is possible not to have a carrying out from a rechargeable battery 400.

The second effect is that because backflow prevention circuits (730,740) which prevents a reverse current flowing is installed in the rechargeable battery 400 via the first conducting devices (710 and 750) when the AC adapter (charger) 100 is inserted, it is possible to prevent an overcharge to the rechargeable battery 400.

The third effect is that because the second loss reduction circuits (770,780) that reduce a loss which occurs in the second conducting device 720A is installed when the AC adapter (charger) 100 is inserted, it is possible to improve a loss.

### Fourth Embodiment

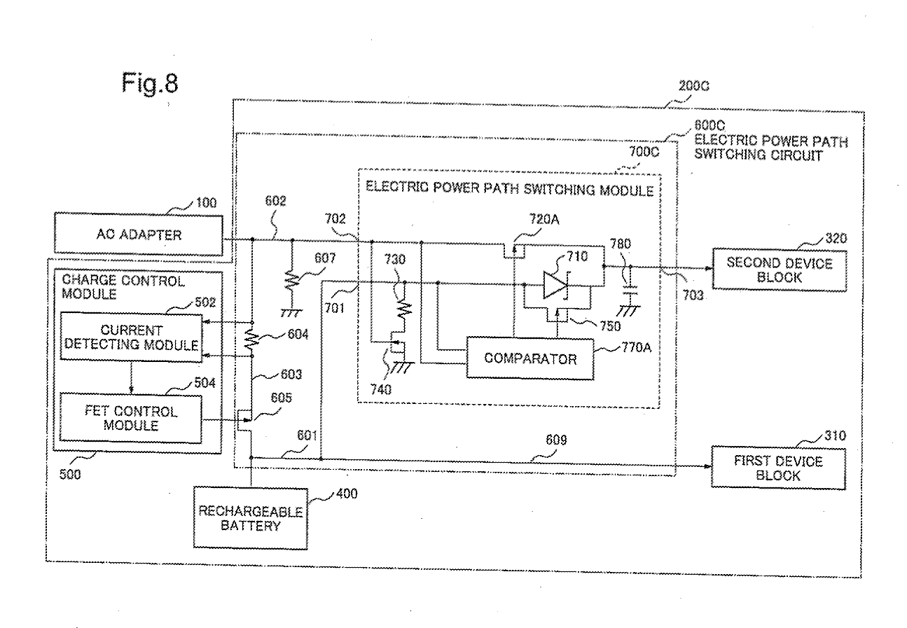

A mobile data terminal 200C including an electric power path switching circuit 600C according to the fourth embodiment of the present invention will be described with reference to FIG. 8. Further, in an example of illustration, although the mobile data terminal 200C is given as an example and being described, it is also applied to other communication devices.

The electric power path switching circuit 600C of illustration has the same configuration as the electric power path switching circuit 600B shown in FIG. 5 and operates except for points that the configuration of an electric power path switching module is changed as described below and that a SBD 611 inserted in a charge path 603 is eliminated. Accordingly, reference numerals of 700C are given to the electric power path switching module. The same reference numerals are given to the same components as shown in FIG. 5, and for the simplification of description, only the points different from the mobile data terminal 200B is hereinafter described.

The electric power path switching module 700C of illustration has the same configuration as the electric power path switching module 700B shown in FIG. 5 except for a point that operation of a comparator differs from the one shown in FIG. 5. Accordingly, the reference numeral of 770A is given to the comparator.

In the electric power path switching circuit 600B according to the third embodiment shown in FIG. 5, because the SBD 611 was added in the charge path 603, the AC adapter (charger) 100 needs to supply the high voltage only for Vf of the SBD 611. However, when a loss of the whole device and the recommendation operating voltage of the connected various devices are considered, it is desirable to drop the voltage of the AC adapter (charger) 100 to the utmost.

In the electric power path switching circuit 600C according to the fourth embodiment shown in FIG. 8, an exemplary configuration when eliminating the SBD 611, is indicated.

However, because there is a wraparound of the voltage from the charge path 603 when eliminating the SBD 611 as described in the third embodiment, comparator operation is not performed correctly.

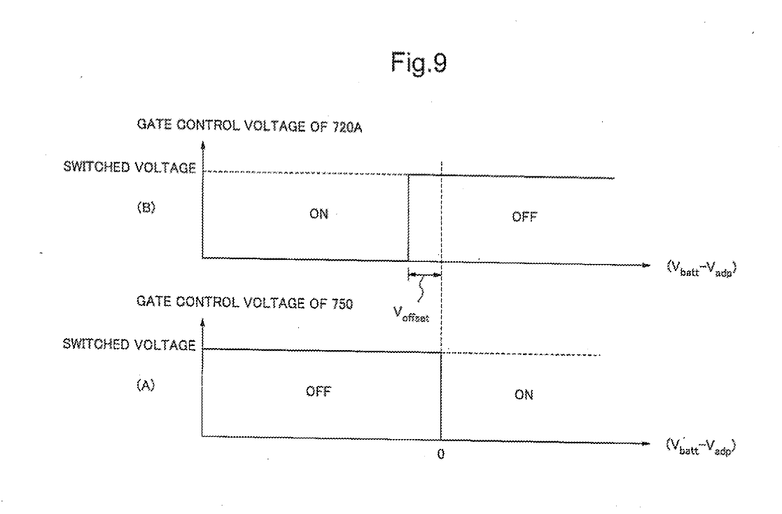

Therefore, in the electric power path switching circuit 600C according to the fourth embodiment, the comparator 770 shown in FIG. 5 is changed to a comparator 770A with the characteristics shown in FIG. 9.

FIG. 9 is a figure showing a control method of the comparator 770A. In FIG. 9, (A) indicates a gate control voltage of a first P-channel MOSFET 750, and (B) indicates a gate control voltage of the second P-channel MOSFET 720A. In (A) and (B) of FIG. 9, the horizontal axis indicates (Vbatt−Vadp), and the vertical axis indicates the gate control voltage (the switched voltage).

An offset is being put on the comparator 770A so that a control difference with the comparator 770 is the gate control voltage of the second P-channel MOSFET 720A, and an AC adapter voltage Vadp may be shown smaller than the original value.

More specifically, as shown in FIG. 9(A), the comparator 770A makes the gate control voltage of the first P-channel MOSFET 750 as a logical low level when the battery voltage Vbatt is higher (Vbatt>Vadp) than,the AC adapter voltage Vadp, and as a logical high level when it is lower (Vbatt<Vadp).

On the other hand, as shown in FIG. 9(B), the comparator 770A makes the gate control voltage of the second P-channel MOSFET 720A as a logical high level when the battery voltage Vbatt is higher (Vbatt>(Vadp−Voffset)) than the voltage (Vadp−Voffset) that only offset voltage Voffset deducted from the AC adapter voltage Vadp, and as a logical low level when it is lower (Vbatt<(Vadp−Voffset)).

By controlling as above-mentioned, when the AC adapter (charger) 100 is removed from the mobile data terminal (communication device) 200C during a charge of the rechargeable battery 400, the second P-channel MOSFET 720A will be turned off certainly. As a result, it becomes possible to block a path caused by the wraparound of the voltage.

In the fourth embodiment of the present invention described above, there are advantageous effects as described below.

The first effect is that because a device block (load) was divided into two systems in the first device block (the first load) 310 and the second device block (the second load) 320, it is possible to not to have a carrying out from the rechargeable battery 400.

The second effect is that because backflow prevention circuits (730,740) which prevents a reverse current flowing is installed in the rechargeable battery 400 via the first conducting devices (710 and 750) when an AC adapter (charger) 100 is inserted, it is possible to prevent an overcharge to the rechargeable battery 400.

The third effect is that because the second loss reduction circuits (770A and 780) that reduce a loss which occurs in the second conducting device 720A is installed when the AC adapter (charger) 100 is inserted, it is possible to improve a loss.

The fourth effect is that because a comparator having an offset was used as a comparator to compose the second loss reduction circuit, therefore when the AC adapter (charger) 100 is removed during a charge, it is possible to block a path caused by a wraparound of the voltage from the charge path.

Although all parts or some parts of the above-mentioned embodiments may also be described as in the following additions, however it is not limited to the additions described below.
(Addition 1) An electric power path switching method for switching a first electric power path from a built-in rechargeable battery in a communication device and a second electric power path from a charger for charging the rechargeable battery which can be connected to the communication device by plugging in and out, comprising:

dividing a load of the communication device into two systems of a first load and a second load;

supplying electric power to the first load from the first electric power path; and

supplying electric power to the second load from the second electric power path when charging the rechargeable battery by the charger and from the first electric power path when the rechargeable battery is not charged.
(Addition 2) The electric power path switching method according to addition 1, comprising:

dividing two systems of the first load and the second load as to have a current of the whole communication device when driving the rechargeable battery as to become the smallest.
(Addition 3) The electric power path switching method according to addition 2, comprising:

dividing two systems of the first load and the second load as to have a charging current to the rechargeable battery as to become the largest.
(Addition 4) The electric power path switching method according to addition 3, comprising:

allotting a device with a high lower-limit of a recommended operating range to the first load with priority.
(Addition 5) The electric power path switching method according to addition 3, comprising:

by allotting a device with a low upper-limit of a recommended operating range to the first load with priority.
(Addition 6) The electric power path switching method according to addition 3, comprising:

by allotting a device with a high operation frequency to the first load with priority.
(Addition 7) An electric power path switching circuit for switching a first electric power path from a built-in rechargeable battery in a communication device and a second electric power path from a charger for charging the rechargeable battery which can be connected to the communication device by plugging in and out, wherein;

a load of the communication device is divided into two systems of a first load and a second load; and

the electric power path switching circuit comprises:

an electricity feeding path for supplying an electric power to the first load from the first electric power path; and

an electric power switching module for switching the first electric power path and the second electric power path, and supplying the switched electric power to the second load; wherein

the electric power path switching module supplies electric power from the first electric power path to the second load as the switched electric power when the charger is not connected to the communication device and supplies electric power from the second electric power path to the second load as the switched electric power when the charger is connected to the communication device.
(Addition 8) The electric power path switching circuit according to addition 7, comprising:

a charge path which supplies charging current to the second battery from the charger; wherein;

a P-channel MOSFET is inserted to the charge path for controlling the charging current as it will be the predetermined current value.
(Addition 9) The electric power path switching circuit according to addition 8, wherein;

the electric power path switching module comprises a first input edge connected to the first electric power path, a second input edge connected to the second electric power path, and an output edge which outputs the switched electric power; and

the electric power path switching module is configured by;

a first conducting device that is inserted between the first input edge and the output edge, having electric power from the first electric power path conduct to the output edge as the switched electric power; and

a second conducting device that is inserted between the second input edge and the output edge, having electric power from the second electric power path conduct to the output edge as the switched electric power.
(Addition 10) The electric power path switching circuit according to addition 9, wherein;

the first conducting device is configured by a first Schottky Barrier Diode having an anode connected to the first input edge and a cathode connected to the output edge; and

the second conducting device is configured by a second Schottky Barrier Diode having an anode connected to the second input edge and a cathode connected to the output edge.
(Addition 11) The electric power path switching circuit according to addition 9, wherein;

the electric power path switching module further comprising a backflow prevention circuit for preventing a reverse current flowing to the rechargeable battery via the first conducting device from the second load when the charger is connected to the communication device.
(Addition 12) The electric power path switching circuit according to addition 11, wherein;

the reverse current block circuit is configured by;

a resistor by which one end is connected to the first input edge; and

an N-channel MOSFET by which a drain is connected to the other edge of the resistor, a gate is connected to the second input edge, and a source is grounded.
(Addition 13) The electric power path switching circuit according to addition 9, wherein;

the electric power path switching module further comprising a first loss reduction circuit for reducing a loss which occurs in the first conducting device when the charger is not connected to the communication device.
(Addition 14) The electric power path switching circuit according to addition 13, wherein;

the first loss reduction circuit is comprised of:

a P-channel MOSFET by which a drain is connected to the first input edge, a source is connected to the output edge, and a gate is connected to the second input edge; and

a resistor connected between the gate in the P-channel MOSFET and earth terminal.
(Addition 15) The electric power path switching circuit according to addition 9, wherein;

the electric power path switching module further comprising a second loss reduction circuit for reducing a loss which occurs in the second conducting device when the charger is not connected to the communication device.
(Addition 16) The electric power path switching circuit according to addition 15, wherein;

the first conducting device comprises

a Schottky Barrier Diode by which an anode is connected to the first input edge, and a cathode is connected to the output edge; and

a first P-channel MOSFET by which a drain is connected to the first input edge, and a source is connected to the output edge;

the second conducting device comprises

a P-channel MOSFET by which a drain is connected to the second input edge and a cathode is connected is connected to the output edge; and

the second loss reduction circuit is configured of:

a comparator for controlling a gate voltage of the first and the second P-channel MOSFET by the comparison result of comparing the voltage of the first input edge and the voltage of the second input edge.
(Addition 17) The electric power path switching circuit according to addition 16, wherein;

the comparator makes the gate control voltage of the first P-channel MOSFET as a logical low level when the voltage of the first input edge is higher than the voltage of the second input edge and as a logical high level when it is higher; and

the comparator makes the gate control voltage of the second P-channel MOSFET as a logical high level when the voltage of the first input edge is higher than the voltage of the second input edge and as a logical low level when it is lower.
(Addition 18) The electric power path switching circuit according to addition 17, wherein;

the second loss reduction circuit further comprises capacitor inserted between the output edge and the earth terminal.
(Addition 19) The electric power path switching circuit according to addition 17 or 18, further comprising:

a Schottky Barrier Diode inserted between the output terminal of the charger and the P-channel MOSFET in the charge path.
(Addition 20) The electric power path switching circuit according to addition 16, wherein;

the comparator makes the gate control voltage of the first P-channel MOSFET as a logical low level when the voltage of the first input edge is higher than the voltage of the second input edge and as a logical high level when it is lower; and

the comparator makes the gate control voltage of the second P-channel MOSFET as a logical high level when the voltage of the first input edge is higher than the voltage that deducted only the predetermined offset voltage from the voltage of the second input edge and as a logical low level when it is low.
(Addition 21) The electric power path switching circuit according to addition 20, wherein;

the second loss reduction circuit further comprises a capacitor inserted between the output edge and the earth terminal.

In patent document 1-4 mentioned above, there are problems as described below.

First, in patent document 1, in order to avoid a carrying out from a rechargeable battery, the charging current is made large. However, because a loss of FET established between the charger (AC adapter) and the rechargeable battery becomes great when the charging current is made large, it will not thermally last. As a result, a radiation measure or the like at the external will be needed, and there is a problem that the merit of using the simple linear charge will disappear.

Patent document 2 is not considering a linear charge.

Patent document 3 has 2 systems of a USB bus power source and an AC adapter power supply for a charge path, and it differs from only one system of the AC adapter power supply in a charge path which the present invention has as an object.

Patent document 4 simply just discloses a power source switching circuit which can certainly switch the voltage from the external power supply to a battery when supply is suspended, and there is no recognition of above-mentioned carrying out from a rechargeable battery.

An exemplary advantage according to the invention is that a radiation measure is unnecessary and it is possible not to have a carrying out from a rechargeable battery to occur. As a result, in a linear charge, it is possible to correspond to a communication device with a larger electric power than the conventional ones.

Although the present invention has been described with reference to the embodiments (working examples) above, the present invention is not limited to the above-mentioned embodiments (working examples). The composition of the present invention and details can have various modifications that a person skilled in the art can understand in the scope of the present invention. For example, in the above-mentioned embodiments (working examples) the case of a mobile data terminal as a communication device is described as an example, but the present invention is also applicable in other communication devices. Further, the above-mentioned embodiments (working examples) the case of an AC adapter as a charger is described as an example, but the present invention is also applicable in other chargers.

Further, it is the inventor's intention to retain all equivalents of the claimed invention even if the claims are amended during prosecution.

What is claimed is:

1. An electric power path switching method for switching a first electric power path from a built-in rechargeable battery in a communication device and a second electric power path from a charger for charging the rechargeable battery which can be connected to the communication device by plugging in and out, comprising:
dividing a load of the communication device into two systems of a first load and a second load;
supplying electric power to the first load from the first electric power path; and
supplying electric power to the second load from the second electric power path when charging the rechargeable battery by the charger and from the first electric power path when the rechargeable battery is not charged.

2. An electric power path switching circuit for switching a first electric power path from a built-in rechargeable battery in a communication device and a second electric power path from a charger for charging the rechargeable battery which can be connected to the communication device by plugging in and out, wherein;
a load of the communication device is divided into two systems of a first load and a second load; and
the electric power path switching circuit comprises:
an electricity feeding path for supplying an electric power to the first load from the first electric power path; and
an electric power switching module for switching the first electric power path and the second electric power path, and supplying the switched electric power to the second load; wherein
the electric power path switching module supplies electric power from the first electric power path to the second load as the switched electric power when the charger is not connected to the communication device and supplies electric power from the second electric power path to the second load as the switched electric power when the charger is connected to the communication device.

3. The electric power path switching circuit according to claim 2, wherein;
the electric power path switching module comprises a first input edge connected to the first electric power path, a second input edge connected to the second electric power path, and an output edge which outputs the switched electric power; and
the electric power path switching module is configured by;
a first conducting device that is inserted between the first input edge and the output edge, having electric power from the first electric power path conduct to the output edge as the switched electric power; and
a second conducting device that is inserted between the second input edge and the output edge, having electric power from the second electric power path conduct to the output edge as the switched electric power.

4. The electric power path switching circuit according to claim 3, wherein;
the first conducting device is configured by a first Schottky Barrier Diode having an anode connected to the first input edge and a cathode connected to the output edge; and
the second conducting device is configured by a second Schottky Barrier Diode having an anode connected to the second input edge and a cathode connected to the output edge.

5. The electric power path switching circuit according to claim 3, wherein;
the electric power path switching module further comprises a backflow prevention circuit for preventing a reverse current flowing to the rechargeable battery via the first conducting device from the second load when the charger is connected to the communication device.

6. The electric power path switching circuit according to claim 3, wherein;
the electric power path switching module further comprises a first loss reduction circuit for reducing a loss which occurs in the first conducting device when the charger is not connected to the communication device.

7. The electric power path switching circuit according to claim 3, wherein;
the electric power path switching module further comprises a second loss reduction circuit for reducing a loss which occurs in the second conducting device when the charger is not connected to the communication device.

8. The electric power path switching circuit according to claim 7, wherein;
the first conducting device comprises
a Schottky Barrier Diode by which an anode is connected to the first input edge, and a cathode is connected to the output edge; and
a first P-channel MOSFET by which a drain is connected to the first input edge, and a source is connected to the output edge;
the second conducting device comprises
a P-channel MOSFET by which a drain is connected to the second input edge and a cathode is connected is connected to the output edge; and
the second loss reduction circuit is configured of:
a comparator for controlling a gate voltage of the first P-channel MOSFET and the second P-channel MOSFET by the comparison result of comparing the voltage of the first input edge and the voltage of the second input edge.

9. The electric power path switching circuit according to claim 8, wherein;
the comparator makes the gate control voltage of the first P-channel MOSFET as a logical low level when the voltage of the first input edge is higher than the voltage of the second input edge and as a logical high level when it is higher; and
the comparator makes the gate control voltage of the second P-channel MOSFET as a logical high level when the voltage of the first input edge is higher than the voltage of the second input edge and as a logical low level when it is lower.

10. The electric power path switching circuit according to claim 8, wherein;
the comparator makes the gate control voltage of the first P-channel MOSFET as a logical low level when the voltage of the first input edge is higher than the voltage of the second input edge and as a logical high level when it is lower; and
the comparator makes the gate control voltage of the second P-channel MOSFET as a logical high level when the voltage of the first input edge is higher than the voltage that deducted only the predetermined offset voltage from the voltage of the second input edge and as a logical low level when it is low.
